(19) United States
(12) Patent Application Publication
(10) Pub. No.: US 2023/0096388 A1
(43) Pub. Date: Mar. 30, 2023

(54) THERMO-FLUORESCENT OPTICAL FIBER, MANUFACTURING METHOD AND APPLICATIONS

(71) Applicant: COMMISSARIAT À L'ENERGIE ATOMIQUE ET AUX ENERGIES ALTERNATIVES, Paris (FR)

(72) Inventors: Olivier RACCURT, Grenoble (FR); Olivier PONCELET, Grenoble (FR)

(73) Assignee: COMMISSARIAT À L'ENERGIE ATOMIQUE ET AUX ENERGIES ALTERNATIVES, Paris (FR)

(21) Appl. No.: 17/952,424

(22) Filed: Sep. 26, 2022

(30) Foreign Application Priority Data
Sep. 24, 2021 (FR) 21/10067

(51) Int. Cl. G01H 9/00

(52) U.S. Cl. CPC G01H 9/004

(57) ABSTRACT

A thermo-fluorescent optical fiber including a core able to propagate light and a sheath, the fiber carrying at least at one of its ends or at one site along its length, devoid of sheath, the optical fiber being provided with a probe consisting of a matrix having thermo-fluorescent particles, the matrix being photo-polymerized. Also provided is a method that relates to manufacturing such an optical fiber as well as to its applications.

The invention concerns a thermo-fluorescent optical fiber based on thermo-fluorescent particles, a method for manufacturing it, as well as its applications, in particular in an optical fiber temperature sensor.

The optical fiber temperature sensors have been developed to collect precise thermal data on structures or in devices, in particular with a view to detecting anomalies that could affect their safety and reliability. This description will be oriented towards the use of sensors for measuring temperatures in batteries in order to better understand the phenomena that lead to overheating or thermal runaway and to determine their operating condition in real time. Of course, the applications of the sensors of the invention are not restricted to this field, they extend to any industrial, medical, biological sector requiring, at one time or another, the determination of a temperature, this can range from −180° C. to 400° C.

The optical fiber sensors based on sensitive particles use various technologies involving absorption, interferometry, fluorescence, diffraction and/or resonance phenomena. The document, A. Urrutia et al. «Optical fiber sensors based on nanoparticle-embedded coatings», Journal of Sensors, vol. 2015, Article ID805053, 18 pages, 2015 is a summary of the main techniques used to manufacture such sensors. Thus, a method is known for manufacturing an optical fiber functionalized by sensitive particles, consisting in removing at sites along the length of the optical fiber part of the sheath and replacing it with a coating incorporating luminescent particles which will interact with their surroundings to provide a signal. Another method uses a modification of the structure and geometry of the optical fiber over part of its length, according to which, at certain sites, the sheath is removed and then the optical fiber is treated by melting and tapering in the presence of luminescent particles to form sites highly sensitive to the medium in which the optical fiber is exposed.

According to a conventional way of implementing an optical fiber sensor based on thermo-fluorescent particles, a probe based on said particles is deposited at one end of an optical fiber and/or on sites along the length of an optical fiber by a sol-gel method. In operation, absorption or excitation light radiation is sent through the optical fiber to reach the probe. The resulting emission radiation is recovered and returned by the same fiber to a detector (of the photodiode, photomultiplier, spectrophotometer type, etc.) which allows the measurement of the fluorescence signal and therefore the measurement of the temperature by signal processing,

The performance of an optical fiber sensor, in terms of selectivity and accuracy, depends mainly on the qualities of the probe, that is to say the layer of sensitive particles deposited on the optical fiber. This generally consists of a matrix in which sensitive particles have been incorporated and which must allow said particles to access the environmental conditions to which they are sensitive in order to obtain a signal. The nature of the matrix, the integration of the particles, the deposition of the layer on the optical fiber are all subjects which have been the subject of developments among which we can cite matrixes based on porous materials with a high specific surface, for example of the zeolite type with high silica content, based on polymers of the polystyrene, silicone rubber, Nafion® type, based on a gel obtained by the sol-gel method, such as a xerogel.

Despite the efforts made, these techniques have the disadvantage of not allowing sufficient control of the distribution of the particles in the matrix, in terms of quantity, in terms of homogeneity of particle distribution at the concerned sites and in terms of positioning of the particles relative to the core of the optical fiber. All these parameters are however crucial to obtain an optimal result.

The invention provides a solution to the aforementioned drawbacks of the known methods with a method for manufacturing a thermo-fluorescent optical fiber making it possible to control the quantity, the distribution, and also the positioning of the sensitive particles in the film deposited on the optical fiber.

Thus, the invention concerns a method for manufacturing a thermo-fluorescent optical fiber, comprising the following steps;

an optical fiber is provided, comprising a core able to propagate light and a sheath, said optical fiber having at least one end and/or one site along its length, devoid of sheath, said end and/or said site being able to irradiate light radiation from the core of the optical fiber,

at least one photo-polymerizable system comprising at least one photo-polymerizable monomer and thereto-fluorescent particles is deposited on said end and/or said site of the optical fiber,

radiation is sent into the optical fiber activating the photo-polymerization of said photo-polymerizable system to form a photo-polymerized matrix comprising said particles, and thus obtain said thermo-fluorescent optical fiber.

The invention also relates to a thereto-fluorescent optical fiber comprising a core able to propagate light and a sheath, said fiber carrying at least at one of its ends or at a site along its length, devoid of sheath, a probe consisting of a matrix comprising thereto-fluorescent particles, the matrix being photo-polymerized, and extends to any application of such a thermo-fluorescent optical fiber, and in particular to a temperature sensor comprising such a thereto-fluorescent optical fiber. Thus, the invention concerns the use of such a temperature sensor, to determine the temperature of an electrochemical generator, such as a battery and in particular a Li-ion battery.

Before exposing the invention in more detail, certain terms/expressions used in this text are defined.

By particles is meant inorganic or organic particles, of any size, being totally or partially coated, encapsulating and/or incorporating at least one thermo-fluorescent molecule. They are of micrometric, sub-micrometric or nanometric size. For the purposes of measuring temperatures in batteries according to a particular application of the invention, they advantageously have a size comprised between 1 nm and 10 μm.

The term «thermo-fluorescence» is understood as the ability of a material to emit almost instantaneously, at a given temperature and under the effect of light radiation called absorption or excitation radiation, light radiation of the same wavelength or of different wavelength called emission radiation. The light radiation emitted by the thermo-fluorescent material is characterized by an emission spectrum comprising one or more peaks whose intensity and or luminescence lifetime varies according to the temperature.

In accordance with the presentation of the invention above, the method of the invention makes it possible, by photo-activated polymerization conducted in situ, to obtain a probe comprising a polymer matrix in which the thereto-fluorescent particles are trapped. By using light radiation passing through the optical fiber as a polymerization agent, the invention has the particular advantage of promoting the formation of a film rich in particles close to the core of the optical fiber, which contributes to the performance of a probe.

Not only does the method of the invention overcome the obstacles of known methods, but it has other advantages such as simple implementation. Thus, since the polymerization of the precursor is photo-activatable, the first step of the method consisting in depositing on said end and/or said site of the optical fiber at least one photo-polymerizable precursor and thereto-fluorescent particles, can be carried out by simple soaking of the fiber in said precursor and said thermo-fluorescent particles.

Only the end and/or the site being accessible to the light radiation sent into the optical fiber, the polymerization of the precursor will only occur in these places.

The various objects of the invention and the particular implementations thereof are set out below in detail, the various stated characteristics being optional and to be considered alone or in combination.

As indicated above, the matrix of a probe of an optical fiber according to the invention is obtained by photo-polymerization of at least one monomer.

The photo-polymerization of a polymer(s) is a reaction well known to those skilled in the art and the choice of the ingredients of an appropriate photo-polymerization system, namely the monomer(s), the photoinitiator(s), and any additional ingredient which would make it possible to increase the qualities of the matrix with a view to greater efficiency of the probe or to facilitate its preparation, belong to the general knowledge of those skilled in the art. It is of course necessary to choose the ingredients compatible with the requirements related to the desired matrix; in particular the polymer must be substantially inert with respect to the thermo-fluorescent particles which will be contained in the matrix; it must also withstand the physical/chemical conditions of the environment in which the optical fiber is used; as previously said, a sensor of the invention is intended in particular for measuring temperatures in batteries which are very acidic environments and whose temperature can reach 150° C. in the event of a malfunction

A photo-polymerizable monomer can be selected from acrylates and methacrylates and in particular methyl-acrylates and methyl-methacrylates; thus, the photo-polymerized matrix is selected from the group of polymers comprising polyacrylates and polymethacrylates and mixtures thereof; methacrylates, which are less reactive, are preferred because they offer greater flexibility of use; said acrylates and methacrylates are advantageously functionalized with at least one function selected from halogens such as bromine or fluorine, sulfur, and aromatic rings; they have the advantage of acting on the refractive index, thus making it possible to control this parameter in the matrix; thus fluorinated acrylate or methacrylate monomers make it possible to achieve refractive index values in the range of 1.4, brominated, sulfur or aromatic acrylate or methacrylate monomers make it possible to achieve refractive index values in the range of 1.8. Of course, several monomers can be used.

According to a preferred implementation of a method of the invention, the photo-polymerization system contains from 70 to 95% by weight relative to the weight of the system, of an acrylate or a methacrylate above, or of any mixture thereof.

As a replacement or preferably in addition to a monomer above, the photo-polymerization system can comprise one or more other monomers which have the power to give the matrix a more or less rigid three-dimensional network. Thus, for a rigid and mechanically resistant three-dimensional network, a monomer will be selected in particular from dipropylene glycol diacrylate (DPGDA), pentaerythritol tetracrylate (FETA), tris[2-(acryloyl)ethyl] isocyanurate TAEI), the isobornyl acrylate (IBOA), tricyclodecandimethanol diacrylate (DCPDA). On the contrary, in search of a mechanically flexible network, substituted silicone-thiol and -vinyl monomers or oligomers will be preferred. The addition of these ingredients allows the surplus to modulate the viscosity of the mixture before polymerization.

According to a preferred implementation of a method of the invention, the photo-polymerization system contains up to 29% by weight relative to the weight of the system, of a monomer or of an oligomer above influencing the three-dimensional network, or any mixture thereof.

The photo-polymerization system can comprise one or more photoinitiators. The choice of photoinitiator depends on the wavelength of the radiation used to activate the generation of radicals and hence the photo-polymerization. This therefore depends on the light source and the ability of the fiber to transport photons in the selected energy range.

In general, the use of type 1 photoinitiators is preferred, and preferably those that do not cause yellowing of the matrix, Type 2 photoinitiators can be used, however they require an amine to stabilize the radicals which has the disadvantage of causing yellowing of the matrix over time. We can however cite methyl benzoyl formate which, although type 2, will not generate yellowing.

Preferred photoinitiators are:

### 1-Hydroxy-cyclohexyl-phenyl-ketone (Irgacure 184)

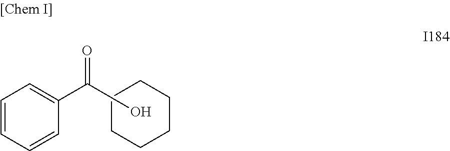

### 2,2-Dimethoxy-1,2-diphenylethan-1-one (Irgacure 651)

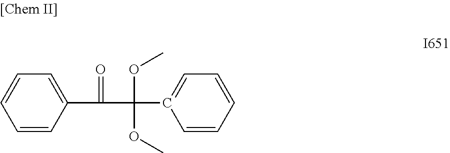 [SMILES: COC(OC)(C(=O)c1ccccc1)c1ccccc1]

### 1-[4-(2-Hydroxyethoxy)-phenyl]-2-hydroxy-2-methyl-1-propan-1-one (lrgacure 2959)

### 2-Benzyl-2-dimethylamino-1-(4-morpholinophenyl)-butanone-1 (Irgacure 369)

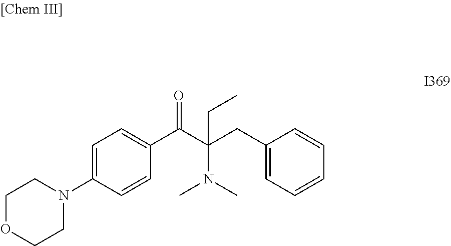 [SMILES: CCC(Cc1ccccc1)(C(=O)c1ccc(N2CCOCC2)cc1)N(C)C]

### 2-Hydroxy-2-methyl-1-phenyl-propan-1-one (Irgacure 1173)

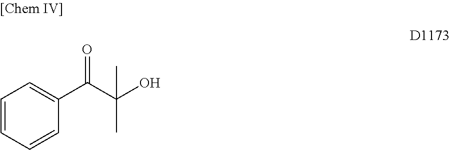

Ivocerin-dibenzoyl germanium (IVO), provided that the environment in which the fiber of the invention will be used is not sensitive to the presence of Germanium

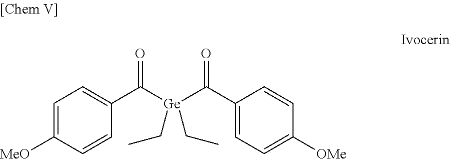

### Trimethylbenzoyldiphenylphosphine Oxide (TPO)

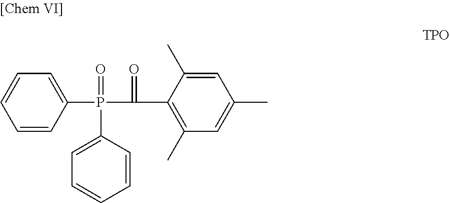 [SMILES: Cc1cc(C)c(C(=O)P(=O)(c2ccccc2)c2ccccc2)c(C)c1]

### Bisacylphosphine Oxide BAPO

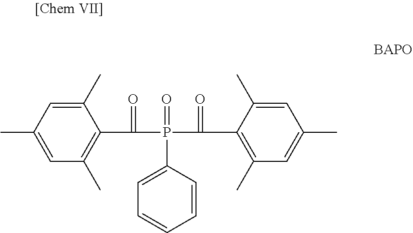

Conventionally, the photo-initiator(s) have a content by weight relative to the weight of the photo-polymerization system in the range of 0.01% to 1%. According to a preferential implementation of a method of the invention, rather high levels of photoinitiator(s) will be retained, in order to obtain rapid freezing of the matrix. High levels make it possible to introduce other ingredients, for example of the additive type, into the photo-polymerization system, without the risk of disturbing the almost instantaneous setting of the matrix.

For example, it may be beneficial to introduce a fluorescent dye which will complement the signal of the thereto-fluorescent particles (or thermo-fluorophore).

A good description of photocurable resins can be found in this review, Samuel Clark Ligon, Robert Liska, Jürgen Stampfl, Matthias Gurr, and Rolf Mülhaupt, Chem. Rev. 2017, 117, 10212-10290.

The photo-polymerization system may also contain one or more stabilizers which may be selected from the stabilizers conventionally used, such as butylhydroxytoluene (BHT) and hydroquinone monomethyl ether (MEHQ). In a preferred operation, these ingredients are added to the photo-stabilization system to stabilize the acrylate and/or methacrylate monomers and then are removed from the system before the addition of the photo-initiator(s), for example by passage over a column of Al(OH)₃.

The photo-polymerization system can be supplemented with any ingredient to optimize the probe. For example, it can be envisaged to add a fluorescent molecule such as fluorescein or any other organic fluorochrome.

It is also possible to add a solvent thereto which may make it possible to promote the wettability of the thereto-fluoroluminescent particles.

The thermo-fluorescent particles may be selected from the families of inorganic, organic or hybrid thereto-luminophores (cf. X. D. Wang, O. S. Wolfbeis, and R. J. Meier, «Luminescent probes and sensors for temperature,» Chem. Soc. Rev., vol 42, No. 19, pp. 7834-7869, 2013, doi: 10.1039/C3CS60102A.). Inorganic agents are generally composed of an inorganic matrix co-doped with metals whose luminescence varies according to the temperature (cf. C. D. S. Brites et al. «Lanthanide-Based Thermometers: At the Cutting-Edge of Luminescence Thermometry,» Advanced Optical Materials, vol.7, no.5, Art. no. 5, 2019, doi: 10.1002/adom.201801239.). Thus, it will be possible to retain nanocrystals based on cadmium selenide, such as those involved in the Quantum Dots technology; materials based on chromic ions (Cr³⁺) as well as particles based on lanthanides such as lanthanum ions (Ln³⁺), as well as chelates based on europium or terbium. As representative thermoluminophores, rhodamine and its derivatives, fluorescein and its derivatives, 7-nitrobenz-2-oxa-1,3-diazol-4-yl (NDB), laurodan, compounds with boro-triaryl base, perylene, N-allyl-N-methylaniline, 1,3-bis-(1-pyrenyl)propane, 1-(N-p-anisyl-N-methyl)-amino-3-anthryl-(9)-propane, acridine, C₆₀ and C₇₀ fullerenes. Among the hybrid agents, one can select metal-ligand complexes such as complexes based on ruthenium (Ru(bpy)₃, Ru(phen)₃, but also complexes based on iridium (Ir(ppy)2(carbac) or platinum (PtII(Br-thq)(acac), PtOEP). It is within the general knowledge of one skilled in the art to select an appropriate agent, in particular according to the temperature range in which the probe must operate.

After the ingredients of the photo-polymerization system and the preparation of a photo-polymerization system, a method for manufacturing a thermo-fluorescent optical fiber according to the invention is exposed in detail.

### Preparation of the Optical Fiber for the Deposition of the Photo-Polymerization System

The method of the invention is compatible with any type of optical fiber. Preference will be given to optical fibers having a core made of silica and a sheath made of doped silica or of a polymer of the fluorocarbon polymer type (Tefzel®). Preferably, they are multi-mode optical fibers. They have a diameter which is preferably from 5 to 200 μm.

If the probe is placed at one end of the optical fiber, it should be prepared to receive the probe and above all to correctly collect the light radiation. To this end, the end of the fiber can for example be planar, although other configurations could be envisaged.

According to an alternative or in addition, the probe can be deposited along the fiber for an evanescent wave measurement. For this purpose, the sheath of the fiber must be removed over a sufficient distance which depends on the probing wavelength used for the thereto-luminophore. The dimension of the site is in the range of a few tens of micrometers or even a few millimeters.

### Deposition of the Photosensitive Precursor on the Optical Fiber

The optical fiber is soaked in the photo-polymerization system which, when the fiber is removed, forms a drop at its end. The volume of the drop will depend on the diameter of the fiber, its wettability with respect to the photo-polymerization system and the viscosity of the latter.

### Deposition of Thermo-Fluorescent Particles at the End of the Optical Fiber

The optical fiber with its hanging drop is then brought into contact with thermo-luminescent particles. This bringing into contact can be done by immersing the fiber in the powder, or simply by bringing the end of the fiber into contact with the mat formed by the powder which is placed on a rigid support or a container, It is also possible to place the fiber under a cascade of particles: in this case only the particles in contact with the part of the fiber wetted by the polymer will be retained by capillarity. The particles are advantageously in powder form and can be of the same nature or in mixtures. Thus, a mixture can be made up of thermo-fluorescent particles, absorbing particles and particles having optical properties in order to modify the final optical properties of the probe at the end of the fibre, It is also possible to add inorganic, organic or hybrid luminescent nanoparticles. Metal nanoparticles can also be added to increase absorption by plasmon effect.

Only the end of the optical fiber is brought into contact with the powder

### Deposition of Thermo-Fluorescent Particles on Sites Along the Length of the Optical Fiber

The principle is the same as that of the deposition at one end of the optical fiber. But beforehand, the sheath is removed from an area of the optical fiber in order to be able to create evanescent waves, Sheath removal can be done by chemical etching or mechanical removal. These two methods are known to those skilled in the art, The precursor solution can also be deposited by dipping, in this case the whole fiber is coated but only the zone where the evanescent wave is created when the light radiation activating the photo-polymerization passes through the fiber will be polymerized. According to a variant, the photo-polymerization system can be deposited on said denuded sites in one drop by an inkjet printing method for example.

Polymerization of the monomer(s) of the photo-polymerization system Once the optical fiber is brought into contact with the powder and without changing its position, a light radiation to activate the photo-polymerization is sent into the fiber from the other end of the fiber. It propagates in the core of the fiber to irradiate the end in contact with said particles. Thus activated, the polymerization occurs at the end of the fiber from the surface of the core of the fiber, thus trapping the particles directly in contact with the fiber and thus forming the deposition of a film or probe, on the end of the fiber.

In the event that the entire surface of the end is not completely covered by the film or even to add an additional film to the deposited film, it is possible to repeat the operation, and this as long as the light radiation activating the polymerization can cross the film(s) already deposited. It is an additional advantage of the invention which makes it possible to increase the probe by one or more films, by using, for each film, the same photo-polymerization system and the same thermo-fluorescent particles, or a photo-polymerizable system and/or identical or different thermo-fluorescent particles from time to time, namely by using the same photo-polymerization system and different thereto-fluorescent particles, a different photo-polymerization system and the same thermo-fluorescent particles, or a different photo-polymerization system and different thereto-fluorescent particles.

This method is simple to be implemented and relatively versatile because it allows the incorporation of different types of particles. It is quick to implement and allows precise control of the location of the deposition, thanks to light.

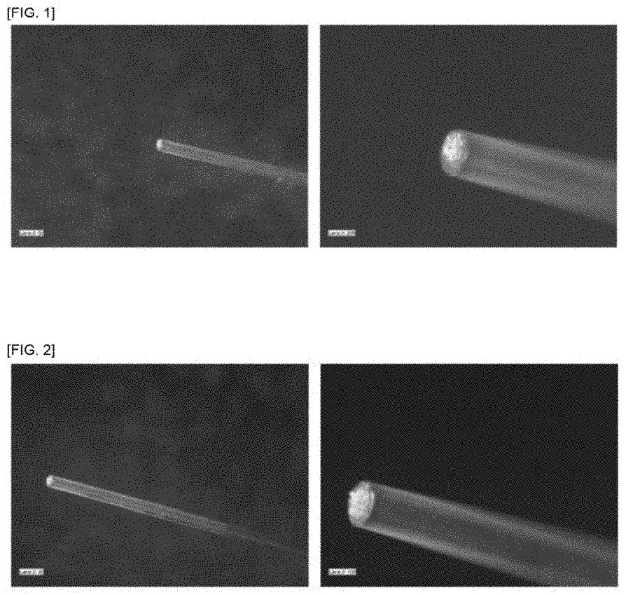

It is illustrated in the following examples in support of FIG. 1 to FIG. 3 according to which:

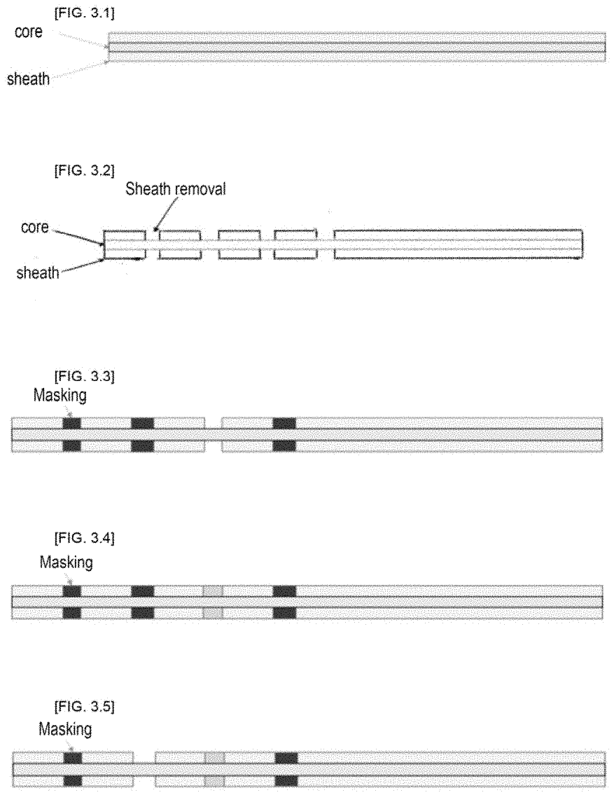

FIG. 1 and FIG. 2 are optical microscope photographs of an optical fiber (diameter 150 μm, reference Thorlabs® M137L02 200 μm in diameter) on one end of which a first film of a matrix containing PTIR545F particles from Phosphor Technology® has been deposited FIG. 1 and a second film from the same matrix FIG. 2; and

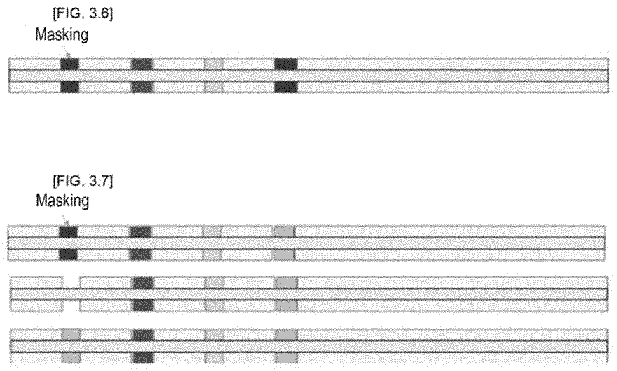

FIG. 3.1 to FIG. 3.7 illustrate implementation variants of the method of the invention.

### EXAMPLE 1

### Preparation of a Photo-Polymerization System

50g of Al(OH)₃ are put in an oven at 150° C. (industrial origin: SASOL) for one night. Then allowed to cool under argon in a Schlenk tube. Then a 20 ml plastic syringe is loaded with 2 g of the powder. At the end of the syringe, a 0.1 μm filter tip is putted. The syringe is filled with methyl methacrylate, then the plunger is replaced and the deprotected monomer is pushed into an opaque bottle containing argon. Argon is bubbled through the bottle to degas traces of O₂.

Next, a second opaque bottle is prepared under argon into which an Irgacure 2959 photoinitiator in powder form (5% by mass relative to the mass of monomer) is introduced, then 0.5 ml of THF ml of acetone. The quantity is deliberately oversized to ensure optimal reactivity of the photo-polymerization system. THF is not necessary but improves wettability.

### EXAMPLE 2

### Manufacture of an Optical Fiber According to the Invention Carrying a Probe at One of its Ends

An exemplary embodiment is illustrated in FIG. 1 and FIG. 2. In FIG. 1, the deposition of a first film of a matrix containing thereto-fluorescent particles is observed. The particles are located exactly at the end of the fiber and nowhere else. The polymer deposition is sufficiently fine and conforms to the optical fiber not to be visible on the photograph. In FIG. 2, the deposition of a second film made on the first film of FIG. 1 is observed. It can be seen that the quantity of particles on the surface has increased. But the deposition remains localized at the end of the fiber.

### EXAMPLE 3

### Manufacture of an Optical Fiber According to the Invention carrying probes, at several sites along its length

This example, in support of FIG. 3, illustrates one of the multiple variants that a method according to the invention allows.

According to the illustrated variant, the method of the invention is carried out on an optical fiber having sites, along its length, devoid of sheath. On some of the bare sites, a mask is applied, so that at the end of the method, the photo-polymerization system has only been activated on the remaining unmasked sites. Then, at least some of the masks are removed and the method is repeated with a different photopolymerizable system, and so on to obtain an optical fiber fitted with different probes.

FIG. 3 illustrates this sequencing:

According to FIG. 3.1, an optical fiber comprising a core able to propagate light and a sheath is provided.

According to FIG. 3.2, certain sites are stripped along the length of the optical fiber by removing the sheath.

According to FIG. 3.3, some of the bare sites are masked.

According to FIG. 3.4, the optical fiber is exposed to a first photo-polymerizable system and the photo-polymerization is activated on the unmasked sites.

According to FIG. 3.5, the masking is removed at some of the bare sites.

According to FIG. 3.6, the optical fiber is exposed to a second photo-polymerizable system and the photo-polymerization is activated on the unmasked sites.

According to FIG. 3.7, the method is repeated as above to obtain an optical fiber provided along its length with different probes.

For example, a polymer that is easy to remove can be used to mask the bare sites of the fiber. Typically, it is a polymer which is not soluble in the solvent used for the deposition of the polymerizable polymer by UV which is used for the deposition of particles. For example, water-soluble polymers with a high molecular point such as PVA (polyvinyl alcohol) or PVP (polyvinylpyrrolidone).

1. A thermo-fluorescent optical fiber comprising a core able to propagate light and a sheath, the fiber carrying at least at one of its ends or at one site along its length, devoid of sheath, a probe consisting of a matrix comprising thermo-fluorescent particles,
wherein the matrix is polymer and photo-polymerized in the presence of the thermo-fluorescent particles.

2. The fiber according to claim 1, wherein the photo-polymerized matrix is selected from the group of polymers comprising polyacrylates and polymethacrylates and mixtures thereof.

3. The fiber according to claim 1, wherein the matrix is in the form of at least two layers, made of identical or different polymers and identical or different thermo-fluorescent particles.

4. A method for manufacturing a thermo-fluorescent optical fiber, comprising the following steps:
An optical fiber is provided, comprising a core able to propagate light and a sheath, the optical fiber having at least one end or one site along its length, devoid of sheath, the end or the site being able to irradiate light radiation, coming from the core of the optical fiber,
At least one photo-polymerizable system comprising at least one photo-polymerizable monomer and thermo-fluorescent particles is deposited on the end and/or the site of the optical fiber, and
Radiation is sent into the optical fiber activating the photo-polymerization of the photo-polymerizable system to form a photo-polymerized matrix comprising the particles, and thus obtain the thermo-fluorescent optical fiber.

5. The method according to claim 4, wherein the photo-polymerizable system comprises at least one photo-polymerizable monomer selected from acrylates and methacrylates and mixtures thereof.

6. The method according to claim 5, wherein the content of acrylate(s) and/or methacrylate(s) is from 70 to 95% by weight relative to the weight of the photo-polymerizable system.

7. The method according to claim 4, wherein the photo-polymerizable system comprises at least one photo-initiator selected from type 1 photo-initiators and methyl benzoyl formate.

8. The method according to claim 4, wherein, after the formation of the photo-polymerized matrix, the steps of depositing on the end and/or the site of the optical fiber are repeated one or several times, at least one photo-polymerizable system and thermo-fluorescent particles, and activating the photo-polymerization of the photo-polymerizable system by sending radiation into the optical fiber activating the photo-polymerization.

9. The method according to claim 8, wherein the photo-polymerizable system and/or the thermo-fluorescent particles are different from one time to another.

10. A temperature sensor comprising a thermo-fluorescent optical fiber according to claim 1.

11. A method comprising:
applying a temperature sensor according to claim 10 to an electrochemical generator, and
determining a temperature of the electrochemical generator.
